(19) United States
(12) Patent Application Publication
(10) Pub. No.: US 2007/0090937 A1
(43) Pub. Date: Apr. 26, 2007

(54) Method for alerting a vehicle user to refuel prior to exceeding a remaining driving distance

(76) Inventor: Francis R. Stabler, Troy, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/255,283

(22) Filed: Oct. 21, 2005

(51) Int. Cl. B60Q 1/00; G08G 1/123

(52) U.S. Cl. 340/450.2; 340/995.24

(57) ABSTRACT

A method for alerting a vehicle user to refuel prior to exceeding a remaining driving distance includes monitoring vehicle fuel conditions. The remaining driving distance of the vehicle is determined through analysis of the vehicle fuel conditions. The position of the vehicle is monitored, and the user is provided with a location of at least one refueling station within the remaining driving distance of the vehicle.

### TECHNICAL FIELD

The present disclosure relates generally to vehicles, and more particularly to methods for alerting vehicle users to refuel the vehicle.

### BACKGROUND

Vehicle navigation systems are capable of generating vehicle navigation instructions and presenting them to a user. Generally, the user prompts the system and requests a particular navigation route. These navigation routes may include instructions to a particular fueling station. Without such a prompt or request from the user, some current systems may not locate a particular fueling station. In some instances, a user may be unaware of or not paying attention to the fuel level and/or the mileage remaining for the fuel level. In such instances, the user may not prompt the navigation system for instructions.

The fuel station location data in some current systems is located on a compact disc, and may be periodically updated when the user orders and installs a newer version of the CD. As such, the location data on the CD may be at least several months old, and thus could be out of date. Outdated data may be a significant problem for locating refueling stations when new stations are built. This may, in some instances, be a significant problem when attempting to locate stations that supply alternative fuels (e.g. ethanol, hydrogen, electric charging).

An alternate system monitors the amount of fuel remaining in the vehicle, and when the fuel drops below a predetermined level, the vehicle, or navigation system in some instances, alerts the user. A navigation system may then notify the user of all refueling stations within a predetermined radius of the then-current location of the vehicle.

A potential problem with the previously mentioned systems is that the vehicle may not have adequate fuel to reach the suggested fueling station, or the fueling station may not be within the user's current direction of travel.

As such, it would be desirable to provide an improved system for alerting a driver prior to the vehicle running out of fuel.

### SUMMARY

A method for alerting a vehicle user to refuel prior to exceeding a remaining driving distance is disclosed. The method includes monitoring vehicle fuel conditions to determine a remaining driving distance of the vehicle. The position of the vehicle is monitored, and the user is provided with a location of one or more refueling stations within the remaining driving distance of the vehicle.

### BRIEF DESCRIPTION OF THE DRAWINGS

Objects, features and advantages of embodiments of the present disclosure may become apparent by reference to the following detailed description and drawings, in which:

FIG. 1 is schematic diagram depicting an embodiment of a navigation system; and

FIG. 2 is a flow diagram depicting an embodiment of a method for alerting a user of an acceptable remaining driving distance.

### DETAILED DESCRIPTION OF THE EMBODIMENTS

Embodiment(s) of the system and method disclosed herein advantageously allow a vehicle operator to receive an alert to refuel the vehicle prior to exceeding an acceptable remaining driving distance/range. It is to be understood that the user is alerted prior to reaching a position where the vehicle's remaining fuel will not allow the vehicle to reach a refueling station. The remaining driving distance may be automatically and/or continuously computed and/or monitored using the current fuel level and/or the current fuel usage rate. Further, a driving distance to one or more refueling stations within the remaining driving distance may be automatically and/or continuously computed and/or monitored via an on-board navigation system or an off-board system (e.g., a call center).

The system and method may advantageously provide to the user current data regarding the locations of refueling stations within the vehicle's remaining driving distance. The system and method may also optionally advantageously have the computational ability to make logical decisions regarding a preferred location for refueling, given the current position and direction of travel relative to available stations. Embodiment(s) disclosed herein offer the user a choice of refueling locations where possible and provide directions to the nearest and/or selected station within the remaining driving distance.

Still further, the embodiment(s) disclosed herein may alert the user via audible signals and/or non-audible signals (e.g. vibration of a tactile signaling device or illumination of a visual signaling device).

It is to be understood that, as defined herein, a user may include vehicle operators and/or passengers.

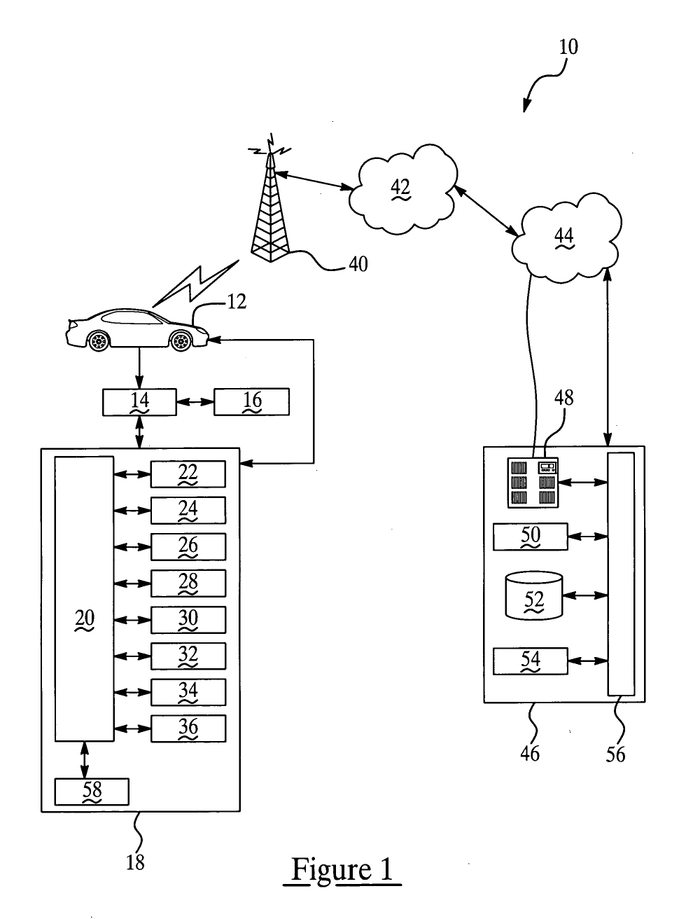

Referring now to FIG. 1, the system 10 includes a vehicle 12, a vehicle communications network 14, a telematics unit 18, a two-way radio frequency communication system (including, but not limited to, one or more wireless carrier systems 40, one or more communication networks 42, and/or one or more land networks 44), and one or more call centers 46. In one embodiment, vehicle 12 is a mobile vehicle with suitable hardware and software for transmitting and receiving voice and data communications. System 10 may include additional components suitable for use in telematics unit 18.

In an embodiment, via vehicle communications network 14, the vehicle 12 sends signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an embodiment, wireless carrier system 40 may be a cellular telephone system and/or any other suitable system for transmitting signals between the vehicle 12 and communications network 42. Further, the wireless carrier system 40 may include a cellular communication transceiver, a satellite communications transceiver, a wireless computer network transceiver (a non-limitative example of which includes a Wide Area Network (WAN) transceiver), and/or combinations thereof.

Telematics unit 18 may include a processor 20 operatively coupled to a wireless modem 22, a location detection system 24 (a non-limitative example of which is a global positioning system (GPS)), an in-vehicle memory 26, a microphone 28, one or more speakers 30, an embedded or in-vehicle mobile phone 32, and/or a short-range wireless communication network 36 (e.g. a Bluetooth® unit).

It is to be understood that the telematics unit 18 may be implemented without one or more of the above listed components, such as, for example, speakers 30. Yet further, it is to be understood that the speaker 30 may be a component of the vehicle audio system, which may accept audio and other signals from the telematics unit 18. Telematics unit 18 may include additional components and functionality as desired for a particular end use.

Processor 20 may be a micro controller, a controller, a microprocessor, a host processor, and/or a vehicle communications processor. In another embodiment, processor 20 may be an application specific integrated circuit (ASIC). Alternatively, processor 20 may be a processor working in conjunction with a central processing unit (CPU) performing the function of a general-purpose processor.

Non-limitative examples of the location detection system 24 include a Global Position Satellite receiver, a radio triangulation system, a dead reckoning position system, and/or combinations thereof. In particular, a GPS provides latitude and longitude coordinates of the vehicle 12 responsive to a GPS broadcast signal received from a GPS satellite constellation (not shown). In-vehicle mobile phone 32 may be a cellular type phone, such as, for example an analog, digital, dual-mode, dual-band, multi-mode and/or multi-band cellular phone.

Associated with processor 20 may be a real time clock (RTC) 34 providing accurate date and time information to the telematics unit hardware and software components that may require date and time information. In one embodiment, date and time information may be requested from the RTC 34 by other telematics unit components. In other embodiments, the RTC 34 may provide date and time information periodically, such as, for example, every ten milliseconds.

Processor 20 may execute various computer programs that interact with operational modes of electronic and mechanical systems within the vehicle 12. It is to be understood that processor 20 controls communication (e.g. call signals) between telematics unit 18, wireless carrier system 40, and call center 46. The processor 20 may have, but is not limited to having, monitoring, computational, decision-making, and communication capabilities.

Further, processor 20 may generate and accept digital signals transmitted between the telematics unit 18 and the vehicle communication network 14, which is connected to various electronic modules in the vehicle 12. In one embodiment, these digital signals activate the programming mode and operation modes within the electronic modules, as well as provide for data transfer between the electronic modules. In another embodiment, certain signals from processor 20 may be translated into vibrations and/or visual alarms.

It is to be understood that software 58 may be associated with processor 20 for monitoring and/or recording the incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center 46. In one embodiment, land network 44 is a public switched telephone network (PSTN). In another embodiment, land network 44 is an Internet Protocol (IP) network. In still other embodiments, land network 44 is a wired network, an optical network, a fiber network, another wireless network, and/or any combinations thereof. The land network 44 may be connected to one or more landline telephones and/or mobile phones. It is to be understood that the communications network 42 and the land network 44 connect the wireless carrier system 40 to the call center 46.

Call center 46 may contain one or more data switches, one or more communication services managers 50, one or more communication services databases 52 containing subscriber profile records and/or subscriber information, one or more communication services advisors 54, and/or one or more network systems 56.

Switch 48 of call center 46 connects to land network 44. Switch 48 transmits voice or data transmissions from call center 46, and receives voice or data transmissions from telematics unit 18 in vehicle 12 through wireless carrier system 40, communications network 42, and land network 44. Switch 48 receives data transmissions from, or sends data transmissions to one or more communication service managers 50 via one or more network systems 56.

Call center 46 may contain one or more service advisors 54. In one embodiment, service advisor 54 may be human. In another embodiment, service advisor 54 may be an automaton.

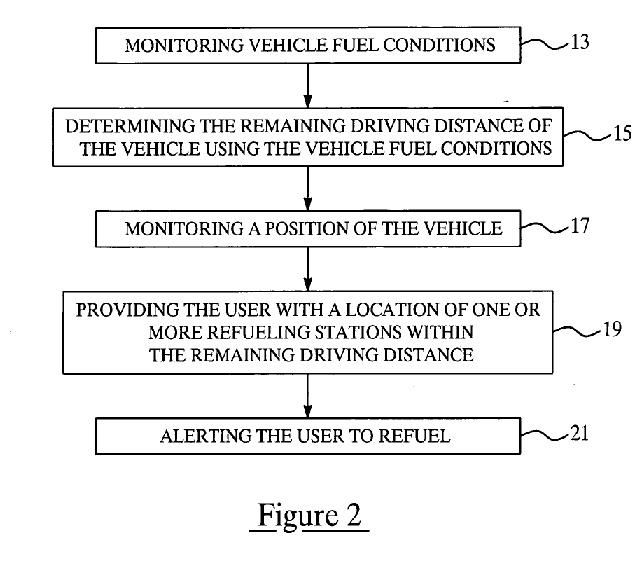

Referring now to FIG. 2, an embodiment of the method is depicted. Generally, the method includes monitoring vehicle fuel conditions, as shown at reference numeral 13; determining the remaining driving distance of the vehicle 12 using the vehicle fuel conditions, as shown at reference numeral 15; monitoring a position of the vehicle 12, as shown at reference numeral 17; and providing to the user a location of at least one refueling station within the remaining driving distance of the vehicle, as shown at reference numeral 19. The method may further include alerting the user to refuel prior to exceeding the remaining driving distance (for example, alerting the user before the quantity of fuel in the vehicle is less than the quantity required for the vehicle to reach a refueling station), as shown at reference numeral 21.

It is to be understood that the position of the vehicle 12 may be monitored using the location detection system 24 operatively disposed in the vehicle 12. The position of the vehicle 12 may be monitored substantially continuously or at predetermined time intervals.

Some vehicle systems 16 and/or the call center 46 are capable of monitoring the vehicle fuel conditions. Non-limitative examples of such fuel conditions include remaining fuel level, fuel usage rate (fuel usage per unit distance traveled), and/or the like, and/or combinations thereof.

In an embodiment, the system(s) 16 monitor the fuel conditions, such as a remaining fuel quantity. The data collected by the system(s) 16 is then transmitted to the vehicle communications network 14, which in turn communicates such data to the telematics unit 18. The telematics unit 18 communicates the data to the call center 46 via the other components in the system 10. The call center 46 may monitor other fuel conditions using the data and other data retrieved. For example, the call center 46 may use the fuel level data and vehicle speed to calculate the fuel usage rate (i.e. the rate at which the vehicle 12 is currently using fuel). In an alternate embodiment, the processor 20 is capable of monitoring the fuel conditions.

Using the data regarding the fuel condition(s), an off-board system (e.g. the call center 46) or the on-board processor 20 is capable of determining a remaining driving distance. It is to be understood that the remaining driving distance is indicative of the mileage that the vehicle 12 may travel with the current fuel level and at the current fuel usage rate. It is to be further understood that the mileage is representative of actual driving distances by highways and streets available to the user. As previously stated, the remaining driving distance may be continuously monitored and updated.

The remaining driving distance may be presented to the user via audible prompts, digital displays (non-limitative examples of which include a multi-function display (MFD), an LCD display, a driver information center display, a radio display, an arbitrary text device, and/or combinations thereof), and/or combinations thereof.

The method further includes monitoring the then-current position of the vehicle 12 and providing the user with a location of (and/or directions to) at least one refueling station within the remaining driving distance of the vehicle 12. It is to be understood that the method includes determining a driving distance to the refueling stations that are within the remaining driving distance.

The call center 46 is capable of accessing a database of the locations of refueling stations and then determining the refueling stations within the remaining driving distance of the vehicle 12. The call center 46 may communicate the location(s) of the refueling stations to the user via the telematics unit 18. In an alternate embodiment, the on-board processor 20 is capable of accessing a database of locations of refueling stations and determining whether the refueling stations are within the remaining driving distance, and providing the locations of the refueling stations to the user. It is to be understood that the refueling station location(s) may be presented to the driver using audio prompts and/or display systems, such as those described hereinabove.

In any of the embodiment(s) disclosed herein, the call center 46 and/or the on-board processor 20 may additionally check the hours of operation for fueling stations and exclude those that are closed at the then-current time.

It is to be understood that the locations, operating hours, type(s) of fuel sold/dispensed, and/or any other relevant data regarding fueling stations may be substantially regularly updated to the vehicle 12 using components of the system 10 that are linked to, for example, a central repository of fueling station data that has the ability to respond relatively quickly to a request to download data. The vehicle's location detection system 24 may provide its location, and the vehicle's systems 16 may provide the estimated remaining driving distance, fuel type, and optionally the last time the database was updated. The central repository would download (for example, to an on-board computer 20 having monitoring, computational, decision making, and communication capabilities) the location of the appropriate refueling stations within the current driving range, taking into account a designated or predetermined margin for error. In a non-limitative example where the vehicle 12 remains in the same area that it was in at the last update, new station locations may be downloaded.

Further, the distance from the then-current vehicle position to any of the locations of the refueling stations within the remaining driving distance may be continuously monitored. Actual driving distance/range of the vehicle 12 may be altered by changes in weather conditions, changes in road conditions (e.g. rural versus city driving, or mountainous versus flat roads), changes in the route stored in the navigation system, and/or the like. In a non-limitative example, if the road or weather conditions slow a driver down, or if the driver is re-routed due to a detour, fuel usage rate may change, thus altering the remaining driving distance/range and potentially altering the fueling locations within the remaining driving distance.

In an embodiment, the fuel station locations provided to the user may be particular to that user and/or vehicle. For example, the call center 46 may have on file that the vehicle 12 requires diesel fuel, and thus will provide to the user the location of fueling stations that sell diesel fuel. Alternately, the vehicle 12 may identify the required fuel type when a fueling station location update is requested or performed.

Upon being presented with various fueling station locations, the user may proceed to any refueling station selected from a list of suitable available alternatives (if any). The user may also initiate a navigation route request to a particular station. Initiation of the request may be verbal and/or via a physical motion. As such, an input system (used to initiate such a request) may include an alphanumeric keypad, a microphone 28, a menu selection system, and/or combinations thereof.

Verbal communication may take place via microphone 28 coupled to the in-vehicle or mobile phone 32 associated with the telematics unit 18. Caller utterances into the microphone 28 are received at a call center 46, which tokenizes the utterance stream for further processing. In one embodiment, the tokenized utterances are placed in a subscriber information database 52 at the call center 46.

Physically initiating a navigation route request may be accomplished via a button press, touch screen, or the like located in the vehicle 12. It is to be understood that the button press or touch screen is operatively connected to the telematics unit 18. Upon the user's initiation of the button press or touch screen, the telematics unit 18 signals the call center 46 of the fact that the user has initiated a request.

In an embodiment, the requested navigation route is generated at the call center 46 via an electronic route generator. It is to be understood that any other suitable route generator may be used to produce the requested navigation route, including a route generator located onboard the vehicle 12. In an alternate embodiment, an on-board navigation system is capable of using the vehicle's current position and the location of the requested refueling station to generate a route. In an embodiment, the navigation route is generated in the form of textual instructions and/or audio prompts and is presented to the user.

The system is capable of alerting the user to refuel before the fuel quantity drops below a level needed to drive to a refueling station. It is to be understood that the system may alert the user one time, or numerous times at predetermined intervals, prior to exceeding the remaining driving distance.

It is to be understood that alerting the user may include: alerting the user to continue driving in a direction (e.g. toward an upcoming fuel station); alerting the user prior to passing the last fueling station within the remaining driving distance/range; and/or alerting the user of a fueling station closest to the vehicle's current position and within the remaining driving distance/range. In an embodiment, alerting the user prior to passing a refueling station within the remaining driving distance may optionally involve logical decisions such as, for example, selecting a refueling station along or near the route to a designated destination although there may be other stations off the route, and selecting a station in the general direction of travel if there is no navigation system destination selected. In another embodiment, if a user has driven past the closest fueling station within the remaining driving distance, the user may be alerted of the location of the past fueling station and instructed to double back on the already driven route.

Alerting the user may be accomplished by audible prompts and/or digital displays, as described herein. In an alternate embodiment, alerting the user may be accomplished by signaling an electronic device (not shown) that is operatively connected to the vehicle 12. The signal may be sent from the call center 46 and/or from onboard the vehicle 12, through the components of the system 10 and ultimately to the electronic device that is operatively connected (by any suitable means, one example of which is via a short range wireless connection) to the telematics unit 18 and the vehicle communication network 14.

Non-limitative examples of such an electronic device are tactile signaling devices, visual signaling devices, audio signaling devices, and/or combinations thereof. The tactile signaling device receives the signal and vibrates or shakes in response thereto. It is to be understood that the tactile signaling device may be implemented at any place in the vehicle 12 (e.g. in the steering wheel) so that the user is alerted when the signal is received.

The visual signaling device receives the signal and may light up, flashes, and/or the like in response thereto. It is to be understood that the visual signaling device may be implemented at any place in the vehicle 12 so that the user is alerted when the signal is received.

It is to be understood that the visual, audio, and/or tactile signal may be accompanied by audio prompts and/or visual prompts on a display device.

Embodiment(s) of the system and method disclosed herein include, but are not limited to the following advantages. A vehicle operator is able to receive an alert to refuel the vehicle prior to exceeding the driving distance to a refueling station that is located within the vehicle's remaining driving distance/range. The remaining driving distance is determined using current fuel conditions and is automatically and continuously monitored and updated. Further, rather than relying on a CD for information that may be outdated, the system disclosed herein is capable of providing current information to the user regarding fueling station locations, hours of operation, driving distance, and the like. Still further, the vehicle's onboard system may also advantageously have the computational ability to make logical decisions regarding a preferred location for refueling, given the current position and direction of travel relative to available stations.

While several embodiments have been described in detail, it will be apparent to those skilled in the art that the disclosed embodiments may be modified. Therefore, the foregoing description is to be considered exemplary rather than limiting.

1. A method for alerting a vehicle user to refuel prior to exceeding a remaining driving distance, the method comprising:
monitoring vehicle fuel conditions;
determining a remaining driving distance of the vehicle using the vehicle fuel conditions;
monitoring a position of the vehicle; and
providing to the user a location of at least one refueling station within the remaining driving distance of the vehicle.

2. The method as defined in claim 1, further comprising alerting the user to refuel prior to exceeding the remaining driving distance.

3. The method as defined in claim 2 wherein alerting the user is accomplished via at least one of audio prompting, visual prompting, or combinations thereof.

4. The method as defined in claim 2 wherein alerting the user includes signaling an electronic device that is operatively connected to the vehicle, thereby alerting the user via the electronic device.

5. The method as defined in claim 4 wherein the electronic device is selected from a tactile signaling device, a visual signaling device, an audio signaling device, and combinations thereof.

6. The method as defined in claim 2 wherein alerting the user further includes at least one of alerting the user to continue in a direction, alerting the user prior to passing a last refueling station within the remaining driving distance, and alerting the user of a refueling station substantially closest to a current position and within the remaining driving distance.

7. The method as defined in claim 1 wherein locations of a plurality of refueling stations are provided to the user, and wherein prior to providing to the user the location, the method further comprises:
initiating, from the user, a navigation route request to one of the plurality of refueling stations;
communicating the navigation route request from the user to a navigation route generator;
generating a navigation route; and
presenting the navigation route to the user.

8. The method as defined in claim 1 wherein monitoring the position of the vehicle is accomplished via a location detection system operatively disposed in the vehicle.

9. The method as defined in claim 1 wherein monitoring the fuel conditions and determining the remaining driving distance are accomplished via one of an on-board computer and a data exchange over a two-way radio frequency communication system between the vehicle and a call center.

10. The method as defined in claim 1 wherein the fuel conditions are selected from a fuel level, a fuel usage rate, and combinations thereof.

11. The method as defined in claim 1, further comprising providing the user with a navigation route to the location of the at least one refueling station.

12. The method as defined in claim 1 wherein the location of the at least one refueling station is provided to the user via at least one of audio prompts, a display device, or combinations thereof.

13. The method as defined in claim 1 wherein the fuel conditions are substantially continuously monitored and wherein the remaining driving distance is substantially continuously updated.

14. A system for alerting a vehicle user to refuel prior to exceeding a remaining driving distance, the method comprising:
means for monitoring vehicle fuel conditions;
means for determining the remaining driving distance;
means for monitoring a position of a vehicle; and
means for providing to the user a location of at least one refueling station within the remaining driving distance of the vehicle.

15. A method for alerting a vehicle user to refuel prior to exceeding a remaining driving distance, the method comprising:
monitoring a position of a vehicle via a location detection system operatively disposed in the vehicle;
monitoring vehicle fuel conditions;
determining a remaining driving distance of the vehicle through analysis of the vehicle fuel conditions;
providing to the user a location of at least one refueling station within the remaining driving distance of the vehicle; and
alerting the user to refuel prior to exceeding the remaining driving distance.

16. The method as defined in claim 15, further comprising providing the user with a navigation route to the location of the at least one refueling station.

17. The method as defined in claim 15 wherein the location of the at least one refueling station is provided to the user via at least one of audio prompts, a display device, and combinations thereof.

18. The method as defined in claim 15 wherein locations of a plurality of refueling stations are provided to the user, and wherein prior to alerting the user to refuel, the method further comprises:
initiating, from the user, a navigation route request to one of the plurality of fueling stations;
communicating the navigation route request from the user to a navigation route generator;
generating a navigation route; and
presenting the navigation route to the user.

19. The method as defined in claim 15 wherein monitoring the fuel conditions and determining the remaining driving distance are accomplished via one of an on-board computer and a data exchange over a two-way radio frequency communication system between-the vehicle and a call center.

20. The method as defined in claim 15 wherein the fuel conditions are selected from fuel level, fuel usage rate, and combinations thereof.

21. The method as defined in claim 15 wherein the fuel conditions are substantially continuously monitored and wherein the remaining driving distance is substantially continuously updated.

22. The method as defined in claim 15 wherein alerting the user further includes at least one of alerting the user to continue in a direction to reach a refueling station, alerting the user prior to passing a last refueling station within the remaining driving distance, and alerting the user of a refueling station closest to a current position and within the remaining driving distance.
